(19) United States
(12) Patent Application Publication
(10) Pub. No.: US 2013/0250110 A1
(43) Pub. Date: Sep. 26, 2013

(54) IMAGE RECORDING APPARATUS AND METHOD FOR VEHICLE

(71) Applicant: Jong Hoan LIM, Seoul (KR)

(72) Inventor: Jong Hoan LIM, Seoul (KR)

(73) Assignee: CORE LOGIC INC., Seoul (KR)

(21) Appl. No.: 13/848,146

(22) Filed: Mar. 21, 2013

(30) Foreign Application Priority Data
Mar. 21, 2012 (KR) 10-2012-0028930

(51) Int. Cl. H04N 7/18

(52) U.S. Cl. CPC H04N 7/181
USPC 348/148

(57) ABSTRACT

Embodiments of the invention relate to a black box system for vehicles, and more particularly to an image recording apparatus and method for detecting image input sources (cameras) to optimally record an image according to the number of image input sources.

The image recording apparatus includes cameras which create and output image signals, a camera detector which detects connection of the cameras, a controller which automatically sets encoding conditions for the image signals of the cameras according to the number of cameras detected by the camera detector, and an image encoder which encodes the image signals output from the cameras according to the encoding conditions set by the controller.

### CROSS-REFERENCE TO RELATED APPLICATION

This application claims priority to Korean Patent Application No. 10-2012-0028930 filed on 21 Mar. 2012, and all the benefits accruing therefrom under 35 U.S.C. §119, the contents of which is incorporated by reference in its entirety.

### BACKGROUND

1. Technical Field

The present invention relates to a black box system for vehicles, and more particularly, to an image recording apparatus and method for detecting image input sources (cameras) to optimally record an image according to the number of image input sources.

2. Description of the Related Art

As generally known in the art, a black box for a vehicle photographs an accident situation using small cameras disposed on front and rear windshields of the vehicle, and collects and stores audio data collected by a microphone in a storage medium, for example, a memory card. The black box normally records situations relating to driving of the vehicle for durations secured by the storage medium. The black box is operated as soon as the vehicle is started, and in the case of an accident, that is, if impact is applied to the vehicle, driver's voice, impact sounds, operating situations of an accelerator, a vehicle speed, a time point, and the like are recorded in the storage medium in detail.

FIG. 1 is a block diagram of a black box system for vehicles in the related art.

Referring to FIG. 1, the black box system includes sensors 14, 16 for detecting a vehicle speed, external impact, and the like, a front camera 11 for photographing a forward image of the vehicle, a rear camera 12 for photographing a rearward image of the vehicle, and a black box 18 for storing vehicle driving information.

The black box 18 includes video encoder 20, video sensor 22 and video decoder 24 which control input and output of video signals by the front and rear cameras 11, 12 and decode or encode the input and output video signals; a microcomputer 28 which controls overall operation of the black box 18; a driving data memory 30 which stores driving situations photographed by the front and rear cameras as video signals for a predetermined period of time set based on a current time by a timer 34; and a video memory 26 which decompresses current video signals recorded in a compressed state in the driving data memory 30 and stores the decompressed video signals.

Further, the black box 18 includes a display unit 44 for displaying video signals stored in the drive data memory 30 and the video memory 26, and an input interface unit 32 for inputting signals of the speed sensor 14 and the impact sensor 16, the vehicle mechanism input signal and the key detection signal to the microcomputer 28.

Normally, the driving data memory 30 repeatedly performs an operation of storing and removing driving conditions of the vehicle at predetermined intervals, and stores a driving condition before and after an accident according to a signal from an impact sensor when the accident occurs.

Such a black box system for vehicles is disclosed in detail in Korean Patent Application No. 1996-000465 entitled “Black Box System for Vehicle”.

However, the black box system in the related art can record an image only for a camera set in advance. For example, the black box system in the related art can record an image of an additional camera only when settings are changed upon installation of the additional camera.

That is, the black box system in the related art cannot actively detect cameras which are image input sources to record optimum images corresponding to the number of image input sources (cameras).

### BRIEF SUMMARY

An aspect of the present invention is to provide an image recording apparatus and method for detecting image input sources (cameras) to optimally record an image according to the number of image input sources.

In accordance with one aspect of the invention, an image recording apparatus for a vehicle includes: one or more cameras which create and output image signals; a camera detector which detects connection of the cameras; a controller which automatically sets encoding conditions for the image signals of the cameras according to the number of cameras detected by the camera detector; and an image encoder which encodes the image signals output from the cameras according to the encoding conditions set by the controller.

The image recording apparatus may further include a storage unit for storing the encoded images output from the image encoder.

The image recording apparatus may further include a lookup table in which the number of frames per second for setting the encoding conditions is stored.

The controller may set the encoding condition with reference to the number of frames per second in the lookup table.

The number of frames per second stored in the lookup table may be inversely proportional to the number of detected cameras.

The number of frames per second stored in the lookup table may provide weight values to the respective detected cameras.

The camera detector may detect connection of the cameras by detecting a physical change occurring when the cameras are connected.

In accordance with another aspect of the invention, an image recording method for a vehicle includes: detecting connections of one or more cameras outputting image signals; setting encoding conditions for the image signals of the cameras according to the number of detected cameras; and encoding the image signals of the cameras according to the set encoding conditions.

In the setting image encoding conditions, image encoding quality of the cameras may be set with reference to the number of frames per second stored in the lookup table.

The encoding conditions may be set in inverse proportion to the number of detected cameras with reference to the number of frames per second in the lookup table.

The encoding conditions may be set according to the weight values applied to the detected cameras with reference to the number of frames per second.

According to the present invention, an image can be optimally recorded according to the number of image input sources (cameras) by automatically detecting connections between the image input sources, thereby acquiring an image for a set camera and improving user convenience of a black box system for vehicles.

### BRIEF DESCRIPTION OF THE DRAWINGS

The above and other aspects, features, and advantages of the present invention will become apparent from the detailed description of the following embodiments in to conjunction with the accompanying drawings, in which:

FIG. 1 is a diagram of a black box system for vehicles in the related art;

FIG. 2 is a block diagram of an image recording apparatus for a vehicle according to one embodiment of the present invention;

FIG. 3 is one example of a lookup table applied to the present invention;

FIG. 4 is another example of a lookup table applied to the present invention; and

FIG. 5 is a flowchart of an image recording method for a vehicle according to one embodiment of the present invention.

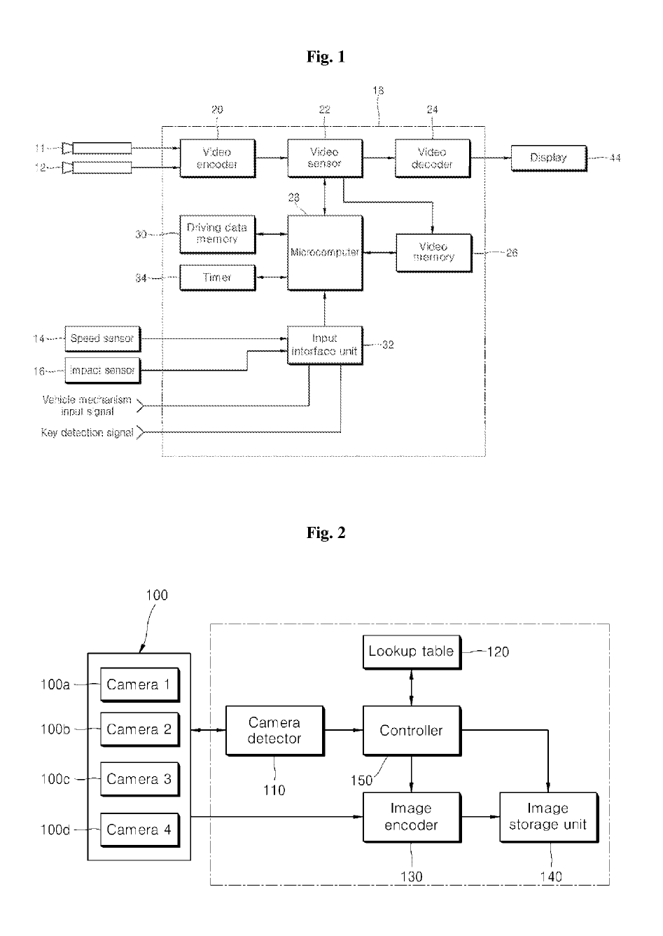

### DETAILED DESCRIPTION

Embodiments of the present invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. Descriptions of details apparent to those skilled in the art will be omitted for clarity.

FIG. 2 is a block diagram of an image recording apparatus for a vehicle according to one embodiment of the present invention. Although four cameras 100a, 100b, 100c, 100d in a connected state are illustrated in FIG. 2, the present invention is not limited thereto.

The cameras applied to the black box system for vehicles are basically connected to a camera detector 110.

One camera of the black box system is generally installed on a front windshield of the vehicle to photograph and store a front peripheral image while the vehicle travels, and the front peripheral image can utilized as evidence in the event of a traffic accident. Recently, an increasing number of vehicles tend to have a plurality of cameras.

Although the black box system for vehicles in the related art has no function of detecting an additionally installed camera so that an expert should set the system again, the present invention can automatically detect the presence of a camera connected to the black box system through the camera detector 110, resolving such an inconvenience.

Specifically, the camera detector 110 detects connection of the camera by detecting a physical change, for example, a change in voltage level occurring when a camera is connected to the black box system. In more detail, the camera detector 110 of the present invention detects a camera based on a serial peripheral interface (SPI) bus signal or an inter-integrated circuit (IIC or I²C) signal used to determine successful establishment of communication between two devices.

The SPI bus is a serial peripheral interface bus and is a synchronization series data connection standard following a Motorola architecture operated in an architecture full-dual communication mode, and the inter-integrated circuit (IIC) bus is a serial computer bus developed by Phillips and is used to connect low-speed peripheral device to a mother board, an embedded system, a mobile phone, and the like.

The cameral detector 110 is connected to one camera, that is, Camera 1 100a, by default. Additionally connected cameras 100b, 100c, 100d are detected through SPI or I2C.

The controller 150 is connected to the camera detector 100, an image encoder 130, and a lookup table 120.

The controller 150 sets encoding conditions of cameras performed by the image encoder 130 according to the number of cameras detected by the camera detector 110.

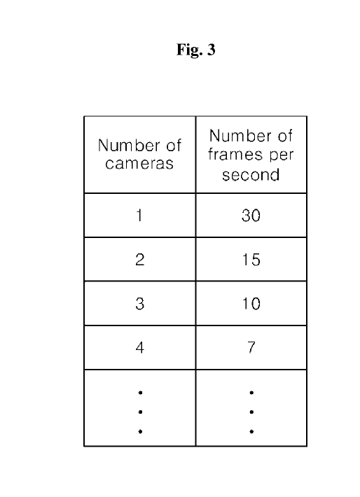

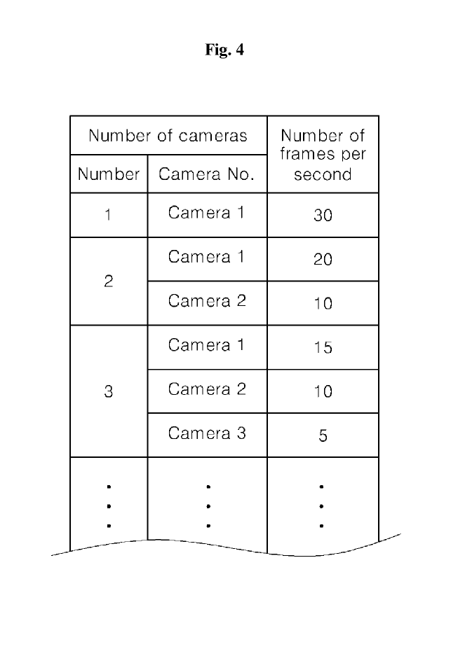

That is, the controller 150 controls the image encoder 130 to encode an image of a camera with an encoding screen quality according to the number of cameras with reference to the lookup tables 120 as shown in FIGS. 3 and 4.

The most currently used black box systems for vehicles record video at 30 frames per second. Thus, if the number of cameras increases, there is a need to set the number of frames per second of each camera. That is, if the number of cameras is at least two, there is a need for adjustment of image encoding qualities (resolution) of the cameras. For example, if the black box system is capable of processing video at 30 frames per second and the number of cameras detected by the camera detector 110 is one, the controller 150 controls the image encoder 130 such that images captured by the one camera 100a can be encoded at 30 frames per second.

In another example, if the black box system is capable of processing video at 30 frames per second and the number of cameras detected by the camera detector 110 is two, the controller 150 may set encoding conditions for images of the two cameras performed by the image encoder 130.

For example, when the controller 150 refers to the lookup table of FIG. 3, the controller 150 may control the image encoder 130 such that the images captured by the two cameras are encoded at 15 frames per second.

That is, when the controller 150 controls the image encoder 130 with reference to the lookup table as shown in FIG. 3, encoding frames per second may be equally divided for the images of the cameras to be encoded according to an equal division condition stored in the lookup table. Thus, when two cameras are detected, the controller 150 may control the image encoder 130 such that the images of the two cameras are encoded at 15 frames per second. When three cameras are detected, the controller 150 may control the image encoder 130 such that the images of the three cameras are encoded at 10 frames per second, and when four cameras are detected, the controller 150 may control the image encoder 130 such that the images of the four cameras are encoded at 7 frames per second.

Further, when the controller 150 refers to the lookup table of FIG. 4, the controller may control the image encoder 130 such that the image of Camera 1 100a is encoded at 20 frames per second and the image of Camera 2 100b is encoded at 10 frames per second.

That is, when the controller 150 refers to the lookup table as shown in FIG. 4 to control the image encoder 130, the encoding frame may be divided differently for the images of the cameras according to a weight value division condition stored in the lookup table to be encoded.

For example, in the lookup table shown in FIG. 4, the maximum number of encoding frames per second may be allocated to Camera 1 100a which photographs a forward image of the vehicle whose importance is highest, considering the locations of the cameras, and the number of encoding frames per second may be sequentially allocated and stored according to order of importance.

Accordingly, when the lookup table of FIG. 4 is referred to and the number of cameras detected by the camera detector 110 is three, the controller 150 may control the image encoder 130 such that images captured by a front camera, for example, Camera 1 100a, are encoded at 15 frames per second. Likewise, the image encoder 130 may control the remaining cameras, for example, Camera 2 100b and Camera 3 100c such that images captured by Camera 2 100b and Camera 3 are encoded at 10 frames per second and/or five frames per second.

The image encoder 130 may encodes the images provided from the cameras under control of the controller 150. The image encoding operation of the image encoder 130 may follow a well-known image encoding technique except that encoding is performed by adjusting the number of frames per second under control of the controller 150 of the present invention.

The image storage unit 140 may be storage media such as SD/Micro SD/SSD/HDD, and may store images encoded and output by the image encoder 130.

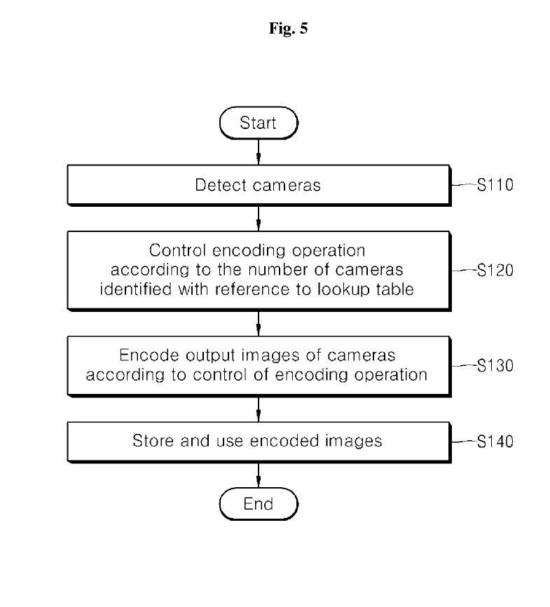

Next, an operation of the image recording apparatus for a vehicle according to the present invention will be described with reference to FIGS. 2 to 5.

First, if electric power is applied to a black box system for vehicles, the camera detector 110 may detect cameras connected to the black box system (S110). Here, the camera detector 110 may automatically detect connection of the cameras using SPI or I2C.

When the cameras connected to the black box system are automatically detected, the controller 150 may identify the number of detected cameras and control an encoding operation of the image encoder 130 according to the number of cameras with reference to the lookup table 120 (S120). Control of the encoding operation in step S120 is performed as described above.

The image encoder 130 may perform an encoding operation upon the images output from the cameras according to control of the encoding operation, for example, control of the number of encoding frames by the controller 150 (S130).

The encoded image data output from the image encoder 130 may be stored in the image storage unit 140 to be used as travel information or accident confirmation material in the case of an accident (S140).

It is apparent that the driving information storage method of the black box system may be performed through an automated procedure according to a time-based sequence by a software program installed in storage media. Codes and code segments of the program may be easily deduced by a computer programmer in the art. In addition, the program is stored in computer readable media and is read and executed by a computer to implement the driving information storage method. The storage media include magnetic recording media, optical recording media, and carrier wave media.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. An image recording apparatus for a vehicle comprising:
cameras which create and output image signals;
a camera detector which detects connection of the cameras;
a controller which automatically sets encoding conditions for the image signals of the cameras according to the number of cameras detected by the camera detector; and
an image encoder which encodes the image signals output from the cameras according to the encoding conditions set by the controller.

2. The image recording apparatus according to claim 1, further comprising a storage unit for storing the encoded images output from the image encoder.

3. The image recording apparatus according to claim 1, further comprising a lookup table in which the number of frames per second for setting the encoding conditions is stored, the controller setting the encoding conditions with reference to the lookup table.

4. The image recording apparatus according to claim 3, wherein the number of frames per second stored in the lookup table is inversely proportional to the number of detected cameras.

5. The image recording apparatus according to claim 3, wherein the number of frames per second stored in the lookup table provides a weight value to each of the detected cameras.

6. The image recording apparatus according to claim 1, wherein the camera detector detects connection of the cameras by detecting a physical change occurring when the cameras are connected.

7. An image recording method for a vehicle comprising:
detecting connection of cameras outputting image signals;
setting an encoding condition for the image signals of the cameras according to the number of detected cameras; and
encoding the image signals of the cameras according to the set encoding conditions.

8. The image recording method according to claim 7, wherein the encoding conditions for the image signals of the cameras are set with reference to the number of frames per second stored in a lookup table.

9. The image recording method according to claim 8, wherein the number of frames per second stored in the lookup table is inversely proportional to the number of detected cameras, and the encoding conditions are set in inverse proportion to the number of detected cameras with reference to the number of frames per second stored in the lookup table.

10. The image recording method according to claim 8, wherein the number of frames per second stored in the lookup table provides a weight value to each of the detected cameras, and the encoding conditions are set according to the weight values applied to the detected cameras with reference to the number of frames per second.
